(19) United States
(12) Patent Application Publication
(10) Pub. No.: US 2002/0170985 A1
(43) Pub. Date: Nov. 21, 2002

(54) Spherical valve with a slanting grip

(75) Inventor: Fu-Jen Tsai, Taichung (TW)

Correspondence Address: DOUGHERTY & TROXELL, SUITE 1404, 5205 LEESBURG PIKE, FALLS CHURCH, VA, 22041, US

(73) Assignee: Shie Yu Machine Parts Industrials Co., Ltd.

(21) Appl. No.: 09/854,633

(22) Filed: May 15, 2001

(51) Int. Cl. B05B 1/30

(52) U.S. Cl. 239/569

(57) ABSTRACT

A spherical valve with a slanting grip includes a valve body provided on top with a fit member slanting in angle, having a valve hole in the center and a stir rod on one side. The stir rod protrudes out of the valve body through the fit member to be fixedly connected with the grip. The grip is positioned in a slanting angle so as to form a comparatively large space for turning around, obtaining effect of easiness and convenience in controlling.

### BACKGROUND OF THE INVENTION

This invention relates to a spherical valve, particularly to one having a slanting grip for controlling with easiness.

A known conventional spherical valve has a grip vertically and fixedly connected to the top of a valve body. The grip functioning to control the spherical-valve needs a comparatively large space for turning around, but, if the grip and the valve body are positioned in perpendicular angle, the grip will be restricted in handling.

### SUMMARY OF THE INVENTION

The objective of the invention is to offer a spherical valve with a slanting grip. A valve body is disposed on top side with a grip fit member slanting in its angle and a sphere provided inside, and a stir rod is provided on one side of the sphere and protrudes out of the valve body through the grip fit member to be fixedly connected with the grip, letting the grip formed into a slant angle so as to control the spherical valve with easiness.

### BRIEF DESCRIPTION OF THE INVENTION

This invention will be better understood by referring to the accompanying drawings, wherein:

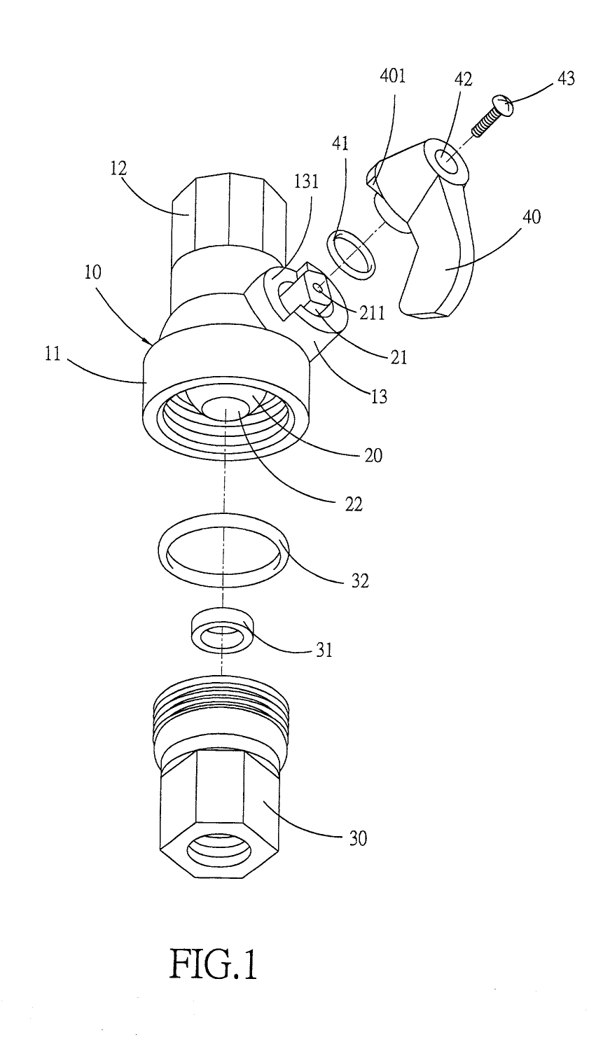

FIG. 1 is an exploded perspective view of a spherical valve with a slanting grip in the present invention:

FIG. 2 is a perspective view of the spherical valve with the slanting grip in the present invention:

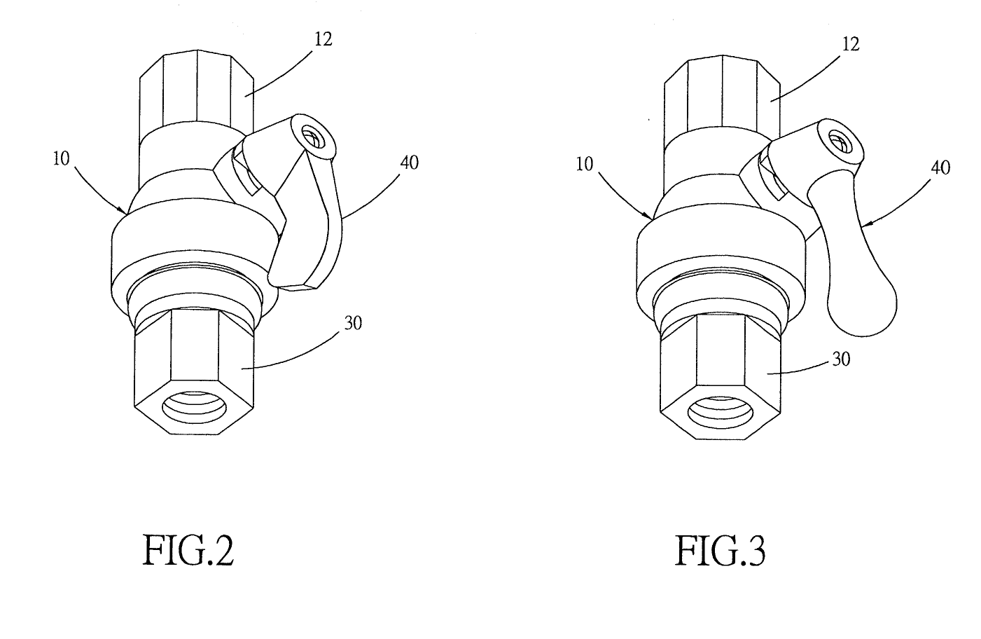

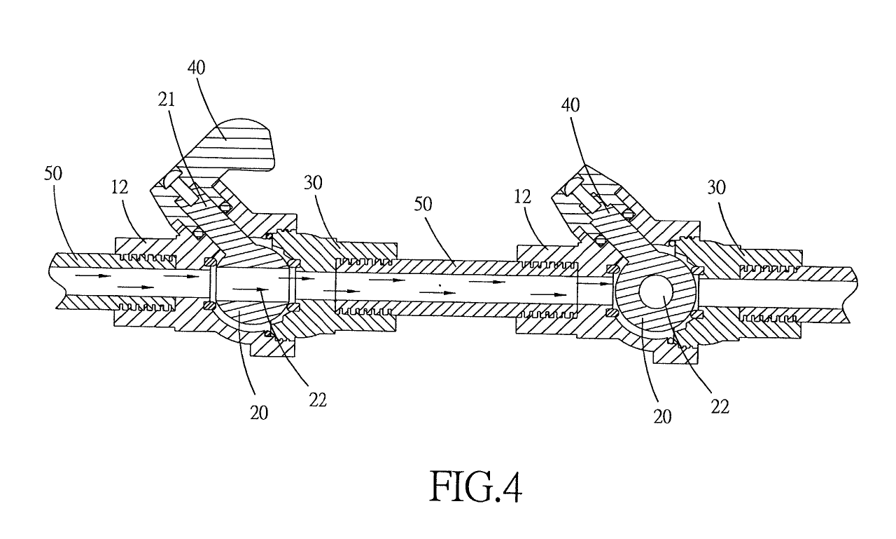

FIG. 3 is a perspective view of the spherical valve with a different-shaped grip in the present invention:

FIG. 4 is a cross-sectional view of the spherical valves with the grip in using condition in the present invention:

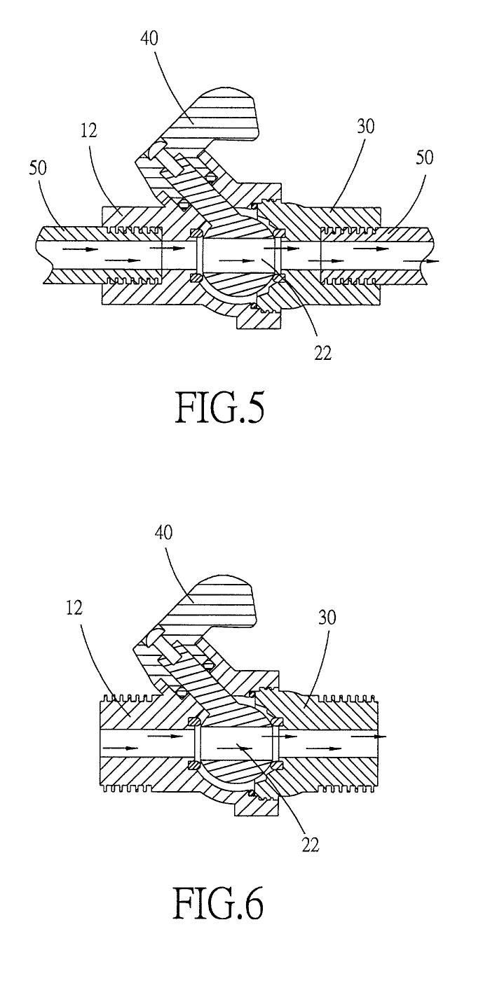

FIG. 5 is a cross-sectional view of a first type of connection between the connecter having female threads and a water pipe having male threads in the present invention:

FIG. 6 is a cross-sectional view of a second type of connection between the connecter having male threads and the water pipe having female threads in the present invention:

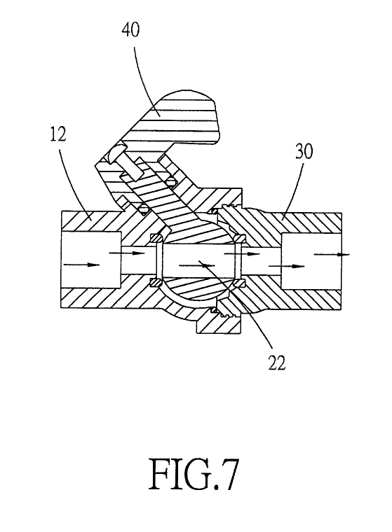

FIG. 7 is a cross-sectional view of a third type of connection between the connecter having stepped holes and the water pipe in the present invention:

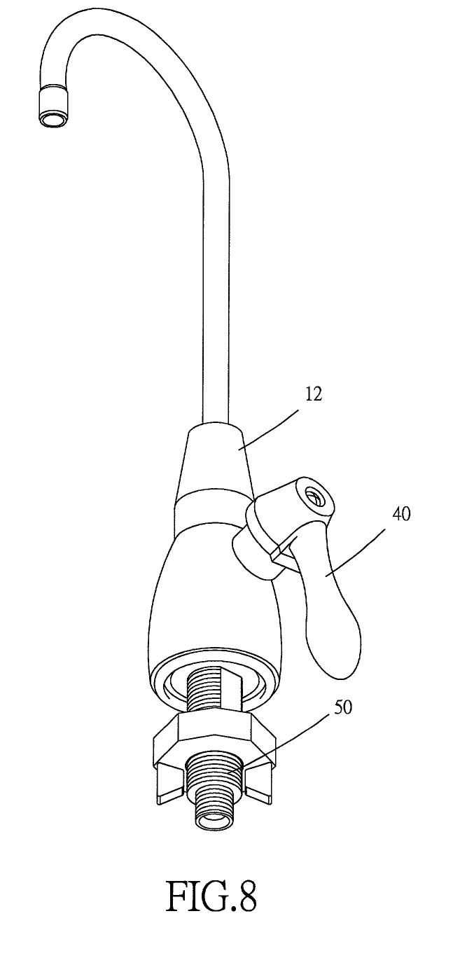

FIG. 8 is a perspective view of an embodiment of the spherical valve applied to a drinking water machine in the present invention.

### DETALED DESCRIPTION OF THE PREFERRED EMBODIMENT

A preferred embodiment of a spherical valve with a slant grip in the present invention, referring to FIGS. 1 and 2, includes a valve body 10, a sphere 20, a second connecter 30 and a grip 40 as main components combined together.

The valve body 10 has a first connecter 12 on top to be connected with a water pipe and a fit member 11 in a convex shape having female threads for engaging the second connecter 30. Besides, the valve body 10 is disposed on one side with a grip connecter 13 slanting in angle and having a groove 131 around the circumferential edge for the engage member 401 of the grip 40 to turn sliding therein.

The sphere 20 has a through valve hole 22 communicating from its bottom center to its top and a stir rod 21 provided on one side, slanting in an angle with the valve hole 22 and its slanting degree being the same as that formed between the valve body 10 and the grip connecter 13. In addition, the stir rod 21 has a threaded hole 211 on top for screwing together with the grip 40 by means of a screw 43.

The second-connecter 30 has male threads around an upper portion for fixedly engaging the fit member 11 of the valve body 10 and a hexagon lower portion and further has an O-shaped washer and a gasket fitted in the upper portion for preventing leakage.

The grip 40 engaged with the grip connecter 13 of the valve body 10 has a through hole 42 on top for screwing together with the stir rod 21 of the sphere 20 by means of the screw 43, and then, an o-shaped washer 41 is fitted between the grip 40 and the stir rod 21 for preventing leakage. Additionally, the grip 40 can also be in a shape shown in FIG. 3.

In using, referring to FIG. 4, the first connecter 12 is threadably connected with a water pipe 50 and the second connecter 30 connected with another water pipe 50 having its other end connected to another valve body, forming a series of connection.

When water flows through the water pipe 50 and the first-connecter 12 into the valve body 10, turn open the sphere 20 by means of the grip 40, letting the valve hole 22 and the first connecter 12 and the second-connecter 30 formed with a communicating passage to permit the water flowing straight through the first connecter 12 and the second connecter 30 and then through the water pipe 50 connected to the second-connecter 30 to reach another valve body. And, if the sphere 20 is turned closed at this time, the water inside will stop flowing forward. So it is easy to adjust the water amount flowing and turn on or turn off the water just by controlling the sphere 20 under an open or a closed condition, and also convenient to handle due to the preset slant angle formed between the grip 40 and the valve body 10.

Furthermore, various styles of pivotally connecting a water pipe 50 with both the first-connecter 12 and the second-connecter 30 can be adopted.

One style, as shown in FIG. 5, is to form the first connecter 12 and the second connecter 30 into female threads and the water pipe 50 with male threads for mutual engagement.

Another style, as shown in FIG. 6, is to form the first connecter 12 and the second connecter 30 with male threads and the water pipe with female threads for engaging each other.

Still another style, as shown in FIG. 7, is to form the first-connecter 12 and the second connecter 30 with stepped holes inside for the water pipe 50 to engage therein.

Aside from connecting to an ordinary water pipe, this invention can also be applied to a drinking water machine, referring to FIG. 8. The first connecter 12 is pivotally connected to an outlet pipe and the second connecter 30 pivotally connected to a water pipe 50, which is connected to an inlet pipe; thus, the supply of drinking water can be controlled by the grip 40.

As can be noted, this invention has the following advantages.

1. A preset slanting angle formed between the grip connecter 13 and the valve body 10 enables the grip 40 to be activated within a comparatively large space, facilitating controlling and using.

2. The O-shaped washer 32 in the fit member 11 and the other O-shaped washer 41 around the inner wall of the grip connecter 13 surely prevent any leakage possibly caused by different sizes of the components.

While the preferred embodiment of the invention has been described above, it will be recognized and understood that various modifications may be made therein and the appended claims are intended to cover all such modifications that may fall within the spirit and scope of the invention.

I claim

1. A spherical valve with a slanting grip comprising a valve body, a sphere a second-connecter and a grip:
The valve body provided on top with a first-connecter to be connected with a water pipe:
Characterized by said grip fixedly screwed with a grip connecter of said valve body, and formed to have a preset slanting angle to said valve body.

2. The spherical valve with the slanting grip as claimed in claim 1 , wherein said first connecter and said second connecter are respectively provided with female threads inside for pivotally connecting with water pipes.

3. The spherical valve with the slanting grip as claimed in claim 1, wherein said first connecter and said second connecter are respectively provided with male threads for pivotally engaging water pipes.

4. The spherical-valve with the slanting grip as claimed in claim 1, wherein said first connecter and said second connecter are respectively provided inside with stepped holes for water pipes to engage therein.
